(19) United States
(12) Patent Application Publication
(10) Pub. No.: US 2017/0173466 A1
(43) Pub. Date: Jun. 22, 2017

(54) GAMIFICATION OF ACTIONS IN PHYSICAL SPACE

(71) Applicant: GAME COMPLEX, INC., Austin, TX (US)

(72) Inventor: Brian Fahmie, La Jolla, CA (US)

(73) Assignee: GAME COMPLEX, INC., Austin, TX (US)

(21) Appl. No.: 15/129,753

(22) PCT Filed: Mar. 24, 2015
(86) PCT No.: PCT/US15/22227

§ 371 Date: Sep. 27, 2016

Related U.S. Application Data
(62) Division of application No. 61/971,198, filed on Mar. 27, 2014.

(51) Int. Cl. A63F 13/428; A63F 13/30; G06F 3/01; A63F 13/40; A63F 13/45; A63F 13/65; A63F 13/27; A63F 13/217

(52) U.S. Cl. CPC A63F 13/428; A63F 13/27; A63F 13/30; A63F 13/217; A63F 13/40; A63F 13/45; A63F 13/65; G06F 3/011; A63F 2300/204; A63F 2300/8082; A63F 2300/6009; A63F 2300/69; A63F 2300/1087

(57) ABSTRACT

The invention generally relates to systems and methods for the use of technology in the gamification of physical activity. The invention provides systems and methods that gamify actions taken within physical space to allow a person's physical activity to be woven into an experience in which technology adds layers of meaning such as stories, rewards, statistics, or feedback. In a preferred embodiment, the invention uses a mobile device that senses its own three-dimensional positions in space, the shape of the space around it, or both.

### CROSS-REFERENCE TO RELATED APPLICATION

This application claims the benefit of, and priority to, U.S. Provisional Patent Application Ser. No. 61/971,198, filed Mar. 27, 2014, the contents of which are incorporated by reference.

### FIELD OF THE INVENTION

The invention generally relates to systems and methods for the use of technology in the gamification of physical activity.

### BACKGROUND

Digital media such as video games and television offer a simulated reality but require people to sit in front of a TV. Video games use a controller that operates on the basic principle of a remote control—push a button and the game console changes what's on the TV screen. Some newer game consoles respond to a player's motion in space. With a controller tethered to their wrist, or by standing in front of a console camera, a player can bowl or play tennis on the TV screen. While such games may simulate popular activities, they still fundamentally require the players to stand in front of the TV.

When people want to be active, they will go out for a run, go to the gym, go to a karate class, go skiing, or do some such activity. Such activities require that the video game console be left at home. People enjoy those activities for a variety of accomplishments—winning a race, getting your heart rate up, or experiencing an adrenaline rush by excelling in a difficult situation.

Unfortunately, one must choose to either experience the storied fiction of digital media or to enjoy the rewards of physical activity. While there is some use of digital technology in sports (e.g., RFID tags monitor runners in marathons), people still must generally choose one of entertainment media or physical activity at the expense of the other.

### SUMMARY

The invention provides systems and methods that gamify actions taken within physical space to allow a person's physical activity to be woven into an experience in which technology adds layers of meaning such as stories, rewards, statistics, or feedback. Electronic devices can monitor or react to a person's actions within, and interactions with, the physical space around the person. Such systems can implement a program plan to structure the person's actions as a game or training exercise by presenting images, sounds, goals, scores, messages, encouragement, and other information while the person actively engages with the environment and progresses through the program plan. Systems of the invention can include a dedicated space such as a building, campus, or playing area that is tailored to the program plan. The system can include devices such as monitors, screens, projectors, speakers, cameras, motion detectors disposed within the space to create or augment an immersive experience for the person in the space.

In a preferred embodiment, the invention uses a mobile device that senses its own three-dimensional positions in space, the shape of the space around it, or both. Where the system includes position-sensing, space-sensing mobile device, the progress and interactions of individual participants are tracked with great precision and in real-time. Thus through the use of systems of the invention, a physical activity can become an immersive experience entwined with a fictional story or with immediate performance feedback. Systems of the invention thus provide rich recreational opportunities. Instead of going for a run, a couple of friends can run through a (simulated) castle, battling dragons, for example. Military personnel, law enforcement officers, and emergency first responders can conduct training activities in which their response times, judgment, and accuracy are measured with computer precision.

The invention provides people with a platform for recreational and training activities that are physically stimulating and that also engage the mind through rich digital media. Thus a person can have a best-of-both-worlds experience in which they play out a scene from their favorite movie, or practice challenging maneuvers in a rapidly changing, augmented reality environment.

The invention provides real-time automated gamification of actions within physical reality and may be used to provide a new form of traditional competitions—such as athletic endurance events, sports, games, mental, and skillful competitions—within physical space that create a physical reality experience. The game states of these novel forms of traditional competitions may be governed via a master control system (e.g., instead of only through the use of judges, referees, scorekeepers, or similar). The master control system and methods of the invention can provide sole control over, and automatic integration of, technology functions such as timing clocks, scoreboards, or video replay.

Systems and methods of the invention may use various software and hardware technology to facilitate the implementation of these experiences. This technology may include multi-camera & multi-plane video capture and analysis; real time data transmission, capture, and analysis; biometric and physiological data capture and analysis; radio frequency technology such as RFID; simulated reality technology; augmented reality technology; others; or any combination thereof. However, concepts and methodologies of the invention may be implemented using technologies beyond those listed here. As technology changes and improves, so too will the technology these novel concepts utilize for their implementation. For example, Indoor Positioning System (IPS), non-visible light spectrum cameras, physical wave detection and analysis technology such as quantum mechanical waves via Gaussian wave packet detection and analysis, or any future technology not yet known, may be used with or in place of the present technology listed above.

In certain aspects, the invention provides a system for the gamification of actions in physical space. The system can be operated to get data that describes an action of a person within a space that includes at least one physical feature and determine a relationship between the action and the physical feature. The system evaluates whether the determined relationship satisfies an objective stored in a program plan within the memory.

The system may include a mobile device with its own memory, processor, display, and sensing apparatus that can track its own three-dimensional motion of the mobile device within the space. The sensing apparatus may sense a three-dimensional shape of the physical environment, determine its own orientation within three-dimensional space of the physical environment, or both. The mobile device may also be operable to create a map of the space, store the map in the memory, and display at least a portion of the map on the display device. The motion sensing or space-mapping functions of the mobile device can include capturing hundreds of thousands of three-dimensional measurements per second. The mobile device uses the three-dimensional measurements to create a digital, three-dimensional model of the space and the physical feature and stores the model in memory. The system optionally includes a server computer with its own memory and processor to perform the evaluating step. The server computer may track the progress of participants through the program plan and provide a comparison of the progress of the various participants with each other.

In certain embodiments, the program plan defines a pre-defined game, athletic event, or other physical endeavor requiring a series of physical actions from a player. For example, the game may require a player to reach a series of checkpoints in the space. The physical feature is one of the checkpoints and the system determines whether the person is within a predetermined distance of the physical feature (e.g., if they have reached it or touched it). The program plan can define a gaming or training exercise to be performed by a group of people within the space. In an exemplary embodiment, the program plan defines an exercise comprising a plurality of checkpoint objectives and a final object and the computing device tracks progress of people through the exercise. One of the checkpoints may consist of determining whether a participant has reached the physical feature.

In some embodiments, the program plan includes a pre-defined training exercise for example, for military, law enforcement, or emergency first responders.

Embodiments of the system include a structure such as a dedicated building, campus, or outdoor space. Where the structure is, for example, a building, the structure may be dimensioned so that the action of the person may be performed within the structure, and wherein the physical feature is installed as part of the structure. The space may be provided by a building in which custom fixtures are configured to correspond to features described within the program plan (i.e., the physical feature is one of the custom fixtures).

Other features and effects may be provided by systems of the invention. For example, the mobile device may detect or map the physical feature and provide an augmented reality display showing a representation of the physical feature enhanced with digital imagery. The mobile device may provide haptic feedback as part of the program plan (e.g., vibration means you were shot or your boat is sinking, to give simple illustrative examples). The system may include, besides a server computer and a mobile device that communicate with each other, a peripheral device disposed within the space and configured to capture data within the space and transmit the data to the server computer. The server may process the data from the peripheral device and provide new information to the person via the mobile device, according to computer program instructions provided by the program plan.

In related aspects, the invention provides a method for the gamification of actions in physical space. The method includes getting—using a computer system comprising a processor coupled to a non-transitory memory device—data describing an action of a person within a physical environment that includes at least one physical feature. The data may be obtained by mobile device with a sensing apparatus. A relationship between the action and the physical feature is determined and it is evaluated whether the determined relationship satisfies an objective stored in a program plan within the memory. The evaluation may be done by the mobile device or a server computer provided by the computer system.

The method may include using the mobile device to determine an orientation of the mobile device itself within the physical environment, track the mobile device's 3D motion, sense a 3D shape of the physical environment, or any combination thereof. The mobile device can create, store, and display a map of the physical environment. Embodiments of the method include creating and storing a 3D model of the physical environment and the physical feature.

Methods of the invention may include playing games (e.g., requiring a series of physical actions from one or more players) or training personnel (e.g., military or law enforcement). Methods may include determining whether a person is within a predetermined distance of the physical feature to determine if a player has reached one of a series of checkpoints in the physical environment according to a game or exercise defined in the program plan. In some embodiments, the methods involve tracking and comparing participants' progress through the program plan. Methods may include executing the program plan within or in conjunction within a structure, building, or physical space, such that physical features of the structure are referred to or used by the program plan. The program plan may define an exercise with checkpoint objectives and a final goal (which may relate to specific features in the physical space), and the computing device tracks progress of people through the exercise and determines whether a participant has reached the physical feature.

### BRIEF DESCRIPTION OF THE DRAWINGS

FIG. 1 gives a simplified overview of technology architecture of the invention.

FIG. 2 gives an overview of an experience control system.

FIG. 3 gives an overview of an instance of one experience.

FIG. 4 shows a modular reconfigurable physical structure.

FIG. 5 shows a transformable structure according to certain embodiments.

FIG. 6 gives a perspective view of a transformable structure.

FIG. 7 shows an environment as provided by a system of the invention.

FIG. 8 gives a detail view of a controlled environment.

FIG. 9 illustrates a physical environment provided by the system.

FIG. 10 shows another possible environment provided by the invention.

FIG. 11 shows a physical environment for gamified physical activity.

FIG. 12 gives another view of the environment shown in FIG. 11.

FIG. 13 gives another view of an environment.

FIG. 14 gives another view of a physical environment.

FIG. 15 illustrates a physical environment from a perspective of a participant.

### DETAILED DESCRIPTION

The invention provides implementations of a real-time physical reality immersive experience having gamification of actions taken in physical space. Embodiments are preferably implemented within a space defined by a physical medium in which participants traverse, for example, a course that may have an undetermined or multiple completion combinations. Systems of the invention monitor and make use of participant results.

For example, participants may accumulate points by reaching various checkpoints as detected by devices of the system. Additionally or alternatively, participants may accumulate points based on choices they make at a checkpoint. Individual point values are assigned to each choice. At the conclusion of the experience, results and rankings are calculated using the points accumulated, the choices made, and the actions taken by each participant. Where participant results and rankings are based on points, and those points are based on conscious choices and deliberate physical actions (e.g., instead of only a total elapsed time), the invention provides game-like strategies, interactions, and incentives within the immersive experience.

Embodiments of the systems and methods described herein use space-sensing or position-sensing mobile devices. Such a device can track its own 3-dimensional position or motion, create a 3-dimensional map of the physical environment that surrounds it, or both. The mobile device may include sensors that allow it to make many (e.g., thousands or hundreds of thousands of) measurements per second and update, in real-time, the position and orientation maps of the device itself and the surrounding environment. Additionally, systems of the invention may include other optional technological features such as RFID tags and readers, Indoor Positioning System (IPS), Infrared Stereoscopic Cameras, others, or combinations thereof. Thus the invention provides for the gamification of actions within physical space via tracking with a physical device.

Not only do systems and methods of the invention provide for gaming experiences and technology-enhanced versions of athletic endeavors as well as other endeavors involving the gamification of physical actions, experiences as provided by the invention can include user-defined experiences.

In a user-defined experience, a user may define experience within a set range using customizable parameters predefined by the various control systems. For example, a user may establish that certain points, features, or objectives in the physical space are to be interpreted by the master control system as, for example, toggles, triggers, or goals. This provides a real-world, physically active endeavor similar to custom multiplayer match choices from video games. To give but one illustrative example, a person could set up a “capture the flag” event within a gamespace (imagine a scout leader preparing the gamespace as an exercise for a troop of scouts). This user could define two different points, or physical features, within the gamespace as the “flags” for each team, thus declaring those physical features to each be the goal for the other team.

As discussed herein, systems and methods of the invention may additionally provide experiences that have military applications. To give an example, in a military application, an experience may be defined by an overarching story that provides a mission scenario as a rehearsal medium. Participants may be given backstories. The mission scenario may include non-participant people within the experience (e.g., facility staff may act as “bystander civilians”). Troop participants may interact with remote team leaders. The experience may be populated with civilians, enemies, augmented virtual participants, as well as other unit members. Such a military application may include external interaction with the experience. For example, a simulated missile may be fired from outside the gamespace targeting the gamespace. Preferably, training experiences can provide a continuous progression in the form of scenario updates, etc.

In certain embodiments, an experience of the invention has application in organized sports. Particularly where the gamification mechanics embody such functions as causality, penalties, etc., a pro-sport (or amateur) event can be provided within the game space. A sport application may include non-participant people within the experience such as judges and referees. Embodying the continuous progression mechanic, rules may be updated as the game progresses, tournament results advanced, weather changes may be simulated, etc.

In some embodiments, the invention provides for games or training exercises administered as a program plan via a system of the invention and through the use of a position-sensing or space-mapping mobile device. Systems and methods of the invention provide rich, deep, and engaging experiences. In certain embodiments, the invention may be implemented as a real life video game in which a player's participation is through real physical activity. For example, the system can include a multi-level structure with Hollywood-style set design on a dynamic sound stage to immerse people into a world created using props, set dressing, digital media, or combinations thereof. Systems of the invention can include one or more position-sensing or space-mapping mobile device, RFID devices, IR Cameras, others, or combinations thereof to capture bodies in real time, providing location and action details to the “game”. Physical, mental, and skillful challenges and obstacles are experienced by a person and scored by the system.

In some embodiments, one or more of the participants uses a mobile device within the game space. A mobile device can give a user a “second screen” (e.g., to supplement a primary display), wherein the second screen provides the user with private information (e.g., while a primary screen provides global information). A private, second screen can mimic a HUD for user giving them, for example, a speedometer, a targeting cross-hair, vital measurements, and other real-time data. The ‘physical reality’ choose-your-own-adventure game or race is one exemplary embodiment. See for example, published international patent application WO 2013/138764, the contents of which are incorporated by reference. Embodiments of the invention provide athletic, physical, mental, and/or skillful competitions combined with the gamification of physical reality.

The novel system preferably includes a physical medium. A physical medium, herein referred to as a gamespace, is defined as a three dimensional field of any measurable size within physical reality that can be measured, tracked, captured, recorded, and stored as a quantifiable dataset within the system. A gamespace provides the ability for actions and reactions to occur, from a plurality of actions that may occur within, or to, the gamespace. Preferably, actions that may occur within a gamespace include pre-defined quantifiable data that may be measured in real-time to generate data can be used to automate gamification of physical reality as intended by the experience operations team.

Systems of the invention can use any suitable physical space or medium. For example, a linear course or route with start and finish points, a racetrack, or a playing field may be included. In a preferred embodiment, a 3 dimensional field of any measurable size within physical space (a gamespace), that may or may not have a segmented course or route contained within the field, is used.

Systems of the invention can include a variety of detectors and devices. Devices can be mobile (e.g., and carried by a participant), fixed (e.g., displays or interactive kiosks), autonomous (e.g., RC vehicles), distributed or otherwise disposed within the space. For example, the system may use a biometric reader such as a fingerprint reader to track a user within the space. The system may use facial recognition from live video camera feeds as a unique identifier. Video or holographic display technology may be included to create elements of the experience and associated physical medium/gamespace.

As discussed herein, systems and methods of the invention relate generally to the gamification of actions taken within physical space that is controlled by technology. Systems may be embodied in purpose-built facilities such as consumer/retail recreation spaces or may be embodied in ad hoc environments, distributed environments, repurposed environments, or any other suitable physical environment.

Embodiments of the invention generally involve a physical medium, which may be referred to as a gamespace. The space may include any user-defined gamespace.

Systems and methods of the invention provide or use a variety of technologies and methodologies such as, for example: simulated reality extensions to facilitate Mixed Augmented Reality (MAR); audio/visual feedback and physical reality augmentation presented through audio/visual peripherals; multi-sensory immersive experiences; experience feedback during experience; MAR Feedback (audio/visual); haptic Feedback (e.g., through peripherals); tactile feedback; kinesthetic feedback; participant control; system-controlled timing for simultaneity and real-time interaction; experience accounts; unique identifiers (UIDs); multiple UIDs and sub-identifiers on single objects; experience interaction devices (EIDs); peripheral devices; data capture spots; gamification; defined expected outcomes and undetermined results; non-predefined ‘win’ conditions, open results (think scientific experiment results); non-linear mission simulations; physical performance metrics; causality interactions (e.g., between participants and program plan elements); non-playing characters (NPCs) (i.e. virtual civilians); external or extrinsic interaction with experience; media capture; real-time media tagging; or media streaming, to name a few. Technologies herein may be supported by including system elements such as: multi-camera & multi-plane video capture and analysis; MAR components; data capture and analysis, including biometric and physiological data; EIDs and peripherals; RF technology.

Systems and methods of the invention are operable to obtain data describing an action of a person within a space. Typically, the space will include at least one physical feature that relates to any given program plan to be administered by the system. Data can be obtained by peripheral devices, user input, sensors built into the user's device (e.g., an orientation-sensing or space-sensing mobile device), other mechanisms, or combinations thereof. Data describing a person's action (“action data”) is gamified according to methods reported here. Some embodiments use checkpoints and challenges. However, many other gamification mechanisms can be used to gamify physical reality within the scope of the invention.

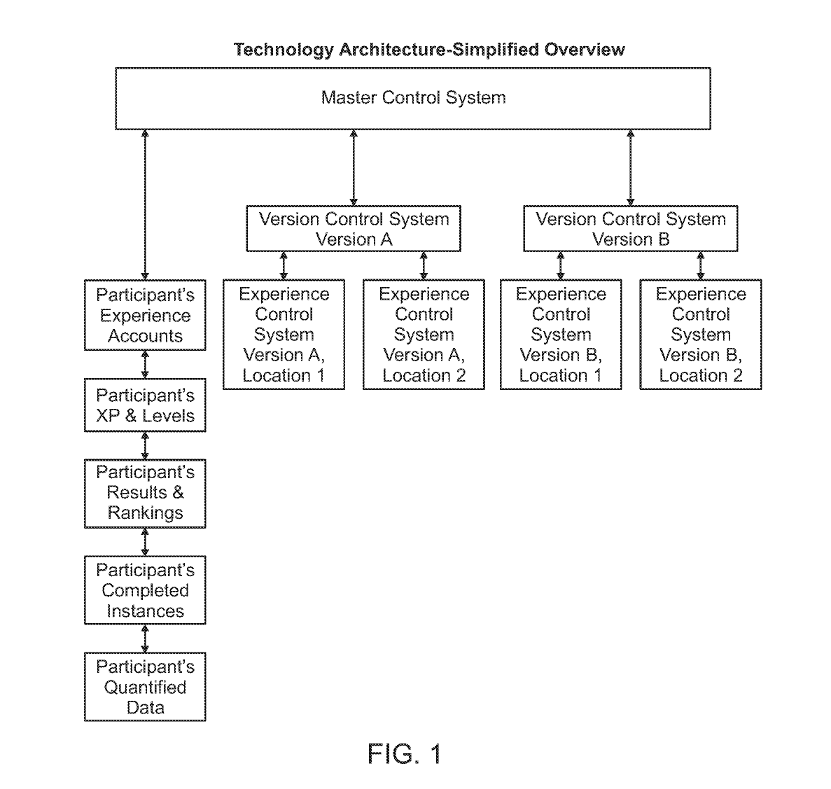

FIG. 1 gives a simplified overview of technology architecture of certain embodiments. The technology architecture includes a master control system that is used in providing a real-time, immersive experience within a physical environment. The real time physical reality immersive experience may further include multiple control systems, some of which are detailed within this disclosure. All of these control systems, detailed or yet defined, are designed, programmed, managed, controlled, and/or updated by an operational team of people called the operations team. These systems can be automatically and/or manually controlled depending on each system's specific requirements.

The master control system includes software and hardware systems that control all the versions, and their respective locations, of the real time physical reality immersive experience. Referring still to FIG. 1, the master control system allows an operations team to design, program, manage, control, and/or update any possible system utilized by the real time physical reality immersive experience. The experience control system may be used to track, capture, record, and store a quantified dataset of each experience. Multiple independent operations teams may exist concurrently for a multiplicity of independent master control systems. Each operations team can determine independently what degree of identicalness constitutes a different version of the experience for each experience managed by their master control system. For example, an operations team may determine that an experience utilizing multi-camera and multi-plane video capture and analysis, and an experience utilizing radio frequency technology, may not constitute different versions of the experience if a participant's interaction with, and results of, both experiences remain constant regardless of the technology differences. In a preferred embodiment, the system includes one or a plurality of space-sensing or position-sensing mobile devices. They system may also include one or a number of server computers. A server computer preferably includes at least one processor coupled to a memory and is able to communicate devices of the invention such as mobile devices or peripheral devices.

For a space-sensing or position-sensing mobile device, any suitable device can be used. For example, a “smartphone” that includes one or more GPS device, accelerometer, laser range finder, compass, clock, or combination thereof, either built into the device or connected to the smartphone device may be used. The device may be provided by a controller device with a custom form-factor such as a game controller device (e.g., with six axis positional sensing). In certain embodiments, a mobile device is a position sensing mobile device such as that described as PROJECT TANGO by Google (Mountain View, Calif.). Preferably the device includes hardware—such as a display device and a sensing apparatus—and software that allow the device to track its own three-dimensional motion of the mobile device within its physical environment. The device may also detect and create a map of that physical environment, store the map in memory, and display at least a portion of the map on the display device. In certain embodiments, the device captures at least 100,000 three-dimensional measurements per second (e.g., about 250,000 3D measurements per second). The device may use the three-dimensional measurements to create a digital, three-dimensional model of the space and the physical feature and store the model in the memory. Device of the invention are part of the technology architecture and can interface with the master control system. Preferably, systems of the invention further include an experience control system.

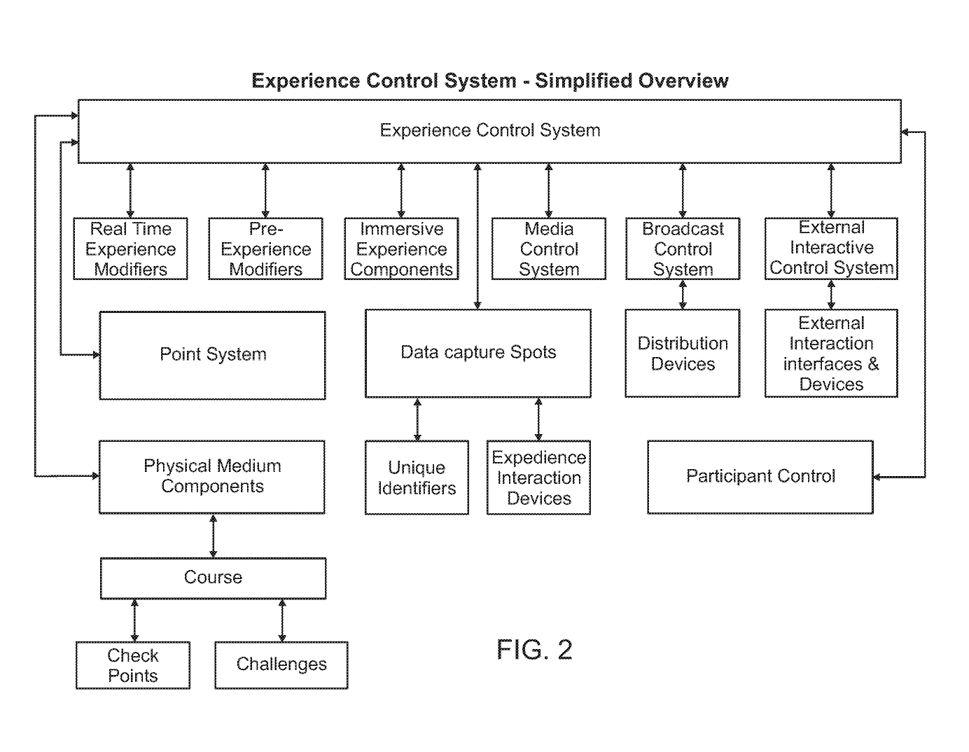

FIG. 2 gives an overview of an experience control system. The experience control system is used to design the real time physical reality immersive experience and to provide different versions of the experience that can exist concurrently. An experience may be embodied in a program plan—i.e., a suite of software code that defines a user's prospective physical actions and the stimulus (e.g., images, sounds, sensations) that the user will experience via interaction with the physical environment provided by systems of the invention. In defining an experience, a program plan can define, for example, a game, an athletic event, a training exercise, a skill building workshop, or other such media. Versions of the experience can differ in any number of ways, including, but not limited to, course design, checkpoint and/or challenge differences, production methods, technology, gamification mechanics, or any other differing elements which cause the experiences to not be identical. As presented in FIG. 2, a course is defined as a route of measurable distance through three-dimensional space that has a starting point and a finishing point. With reference to FIGS. 2 & 3 and the discussion herein, traverse is defined as any measurable physical movement, by any means of movement, along a course. Along the course, participants encounter checkpoints. Checkpoints are defined as a specific section of a course that contains 1 or more challenges. Challenges are defined as physical, mental, and/or dexterous activities; and/or different routes from checkpoint to checkpoint. Challenges are of natural and/or man-made origin. Challenges at times may utilize technology, software and/or hardware systems, to facilitate the challenge's activity(s) and/or routes. Participants must pass through each checkpoint by choosing to complete, or attempt to complete, one, or sometimes more than one, of the challenges at that checkpoint. After a participant completes, or attempts to complete, their selected challenge(s) required of them at a checkpoint, they can continue traversing along the course to the next checkpoint. In the case of challenges being different route options from one checkpoint to another checkpoint, participants must choose to take one of the presented route options to get to the next checkpoint. Participants continue their traverse of the course from the starting point to the finishing point through each checkpoint along the course, thereby completing the experience.

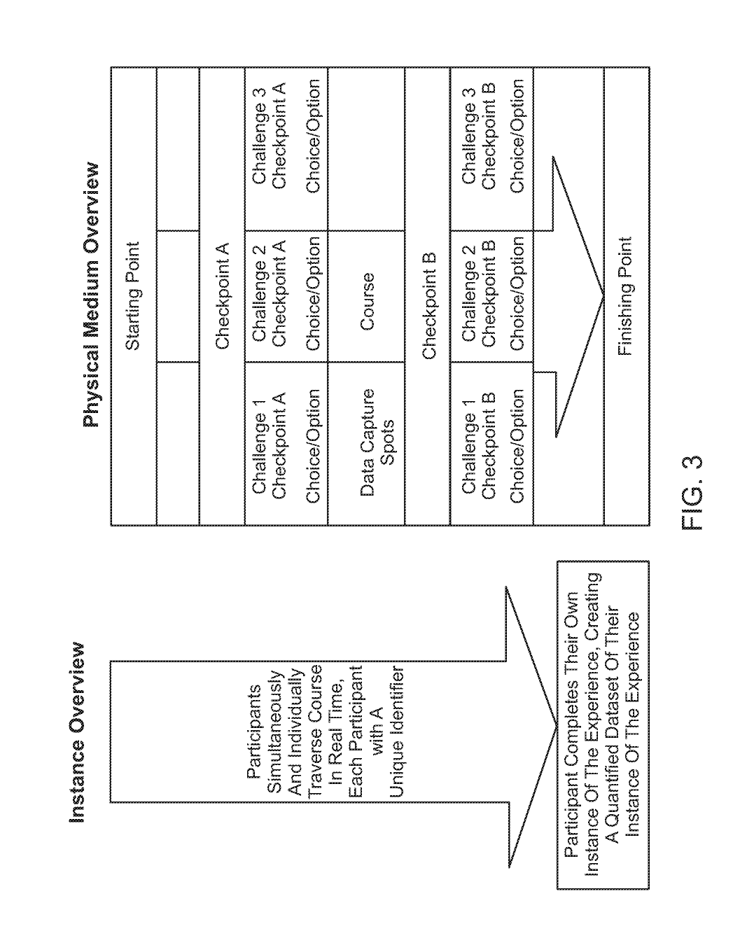

FIG. 3 gives an overview of an instance of one experience and its corresponding physical medium/environment. An instance is defined as a participant's completing of an experience or a defined stage within an experience. Each version of the experience has its own version control system, which is a technical system of software and hardware systems that control each version of the real time physical reality immersive experience. Each version control system communicates with the master control system in real time via data transmissions.

Just as each “experience” can correspond to a different type or category of physical endeavor, so can those experiences be designed to each involve a unique physical environment. In some embodiments, a structure or facility (e.g., building or outdoor park) is designed to be reconfigured for each of several different experiences.

An experience as provided using systems and methods of the invention may involve more than one location (e.g., simultaneously being used by different participants, who can interact with one another across space via the systems described herein). The real time physical reality immersive experience is designed to allow production of multiple locations of a version of the experience so that they may exist concurrently anywhere in the world. Each location of a version of the experience has its own experience control system, which is a technical system of software and hardware systems that control the entire experience at that specific location. Each location's experience control system communicates with its version control system in real time via data transmissions.

Some versions of the experience may use contemporaneous versions. Each location of a contemporaneous version of the experience is identical and all participants are deemed to have partaken in the version of the real time physical reality immersive experience, not in a specific location of the version of the real time physical reality immersive experience. This facilitates the ability to have globalization of participants, such as global ranking systems, as well as segmentation of participants, such as geographic regional ranking systems.

The invention can involves, support, and reward cooperative human efforts. Some versions of the experience may utilize teams of participants completing the experience cooperatively. In these cases, each participant creates an instance of the experience, and collectively the team creates a team instance of the experience.

FIG. 4 shows an exemplary modular reconfigurable physical structure that can be included in system of the invention. Use of a space-sensing or position-sensing mobile device may provide particularly desirable benefits in this context, as the mobile device can instantaneously detect the present configuration of the physical reality and relate that information to the master control system, where it can be verified that the present physical environment corresponds to the appropriate stage of a program plan.

In some embodiments, the real-time physical reality immersive experience is designed to allow production of multiple locations of a version of the experience so that they may exist concurrently anywhere in the world. Each location of a version of the experience has its own experience control system, which is a technical system of software and hardware systems that control the entire experience at that specific location. Each location's experience control system communicates with its version control system in real time via data transmissions.

Some versions of the real time physical reality immersive experience utilize production methods, such as being housed within an enclosed indoor establishment, that necessitate additional safety, emergency, and/or other possible technical systems to produce the experience. These additional systems are controlled at each location of a version of the experience by the location's experience control system.

Each location of a version of the experience is identical and all participants are deemed to have partaken in the version of the real time physical reality immersive experience, not in a specific location of the version of the real time physical reality immersive experience. This facilitates the ability to have globalization of participants, such as global ranking systems, as well as segmentation of participants, such as geographic regional ranking systems. Where multiple locations are used, it is possible—as in all embodiments—to have stages of a program plan administered in real-time.

The real time physical reality immersive experience consists of people performing a physical activity, such as traversing a course, in real time. The experience is designed to allow people to participate in the experience when they so choose at any time there is an available starting time. Each participant's completion of the experience is unique to him or her and creates his or her own instance of the version of the real time physical reality immersive experience.

The real time physical reality immersive experience is designed to allow completion of the experience by multiple participants simultaneously and independently of each other. For example, participants 1, 2, and 3 could start their instances of the experience at 7:00 am. At 7:30 am, participant 1 could have completed their instance of the experience, participant 2 could be nearing the completion of their instance of the experience, and participant 3 could be at the halfway point of completing their instance of the experience. Also at 7:30 am, participant 4 could start their instance of the experience.

The real time physical reality immersive experience utilizes various systems and methods to control participants during the experience. Any suitable combination of technology, software, and hardware systems may be used to control participants. For example, positive or negative reinforcement principals may facilitate participant control.

Types of participant control include, but are not limited to, throughput, bottleneck alleviations, continual traversing of participants, prevention of backwards traversing where prohibited, time to complete instance, individual checkpoint and/or challenge time limits, and/or any other possible types of control over participants needed to facilitate the experience. In one example, to facilitate bottleneck alleviations, the experience control system recognizes a bottleneck of participants and then prevents participants from choosing that challenge until the bottleneck is cleared, before reopening that challenge to be chosen.

In certain embodiments, systems and methods of the invention provide for the use of “accounts” that may be created and accessed by user participants. A participant may have a unique experience account that tracks, captures, records, and stores his or her complete real time physical reality immersive experience history. Every instance of a version of the experience a participant completes creates a quantified dataset of the instance. These datasets are stored within the participant's experience account, the accumulation of which constitutes their complete real time physical reality immersive experience history. Experience accounts may also track, capture, record, and store a complete history of a person's external interactions with the experience. External interactions with the experience are further detailed below.

Systems and methods of the invention may use unique identifiers for each participant. Unique identifiers may be provided as a physical technical device that is affixed to or within each participant, or apparel worn by the participant, during the experience. Each participant is affixed with a unique identifier before the start of the experience. At the conclusion of an instance of the experience, participants have their unique identifiers removed so that the unique identifier can be reused for future participants.

Each unique identifier utilizes technology, software and/or hardware systems, to track, capture, record, and store any and all actions taken by the participant it's affixed to during the experience. Tracked, captured, recorded, and stored data and actions may include, but is not limited to, physical movement within three dimensional space, selected choice from a plurality of choices, physiological data of the participant, timestamps, and participant interactions with the experience systems and mechanisms.

The real time physical reality immersive experience utilizes unique identifiers for each participant so that the experience control system can distinguish each participant and their respective quantified datasets of their instance of the experience from one another in real time.

Unique identifiers are defined as either unique identifying traits of a participant, or, a physical technical device that is affixed to or within each participant or apparel worn by the participant, during an instance of the experience.

During a participant's instance of the experience, data capture mechanisms track, capture, record, and store real time unique identifying data of each participant's unique identifiers within the gamespace simultaneously. Concurrently the experience control system utilizes this real time unique identifying data to identify and distinguish each participant and their respective quantified data generated within the gamespace from one another in real time.

Data capture mechanisms are defined as technology, software and/or hardware systems, that interact with unique identifiers, experience interaction devices, and the experience control system in real time via data transmissions.

During the experience, data capture mechanisms, consciously and/or unconsciously with respect to participants, non-participants, external participants, and the experience, capture quantifiable data of each participant, non-participant, external participant, and the experience itself within the gamespace simultaneously. Quantifiable data captured via these data capture mechanisms are incorporated as part of their respective associated participant's, non-participant's, external participant's, or game state's quantified dataset of their respective instance of the experience.

Tracked, captured, recorded, and stored data and actions may include, but is not limited to, physical movement of objects within three dimensional space, conscious choices from a plurality of choices, actions occurring from a plurality of actions, biometric and physiological data of human participants, timestamps, and/or any and all other quantifiable data that may be tracked, captured, recorded, and stored during an instance of the experience.

In implementations of the concept utilizing unique identifying traits of a participant to serve as their unique identifier, a participant's experience account for the version of the experience stores reference data of their unique identifying traits. This reference data is captured and stored before a participant's first instance of the version of the experience. Reference data may be updated automatically via operational protocols of the various control systems of the experience as often as the operational team for the version of the experience programs these updates to occur.

Unique identifying traits of a participant may include, but are not limited to, biometric and physiological characteristics, apparel worn by the participant, and/or any other unique identifying traits that may be quantifiably stored as reference data and used in conjunction with the participant's real time unique identifying data to identify and distinguish the participant and their respective quantified datasets of their instance of the experience from other participants in real time via computational data analysis algorithms.

Multiple independent algorithms may exist that use different combinations of unique identifying traits and computational data analysis logic for identification. Each operations team may design these independent algorithms to best suit their implementation of the real time physical reality immersive experience.

For example, if fingerprint scans are utilized as the unique identifiers in a version of the experience, each participant's experience account would store a reference fingerprint scan of the participant. Each time a participant interacts with a data capture mechanism during an instance of the experience, in this example scanning his or her finger at a fingerprint scanning station, the resulting real time unique identifying data of the participant's fingerprint scan will allow the experience control system to utilize its specific predefined algorithms to identify and distinguish the participant and their respective quantified dataset of their instance of the experience from other participants in real time.

In implementations of the concept utilizing a physical technical device as the unique identifier, each participant is affixed with a unique identifier before the start of the experience if they don't already have a unique identifier affixed. At the conclusion of an instance of the experience, participants may have their unique identifiers removed, some of which may be recycled and reused for future participants. These physical device unique identifiers utilize technology, software and/or hardware systems, which interact with data capture mechanisms in real time via data transmission during an instance of the experience to facilitate the unique identifier's function.

Implementations of the concept may utilize multiple unique identifiers for a single participant that may allow for additional quantifiable data to be generated. Multiple unique identifiers could be designed to function as a group, or sub group, of other unique identifiers or a group of unique identifiers to facilitate possible gamification mechanics.

For example, a participant could be affixed with a unique identifier on each wrist and each ankle to facilitate generating 6 degrees of freedom data relative to physical movement within 3 dimensional space. This resulting data could be used as a gamification mechanic to affect experience results such as awarding points for visually appealing body positions performed during an instance of the experience. Systems and methods of the invention may use various gamification mechanics to signify the start and end of the experience and generate gamification of the experience by analyzing the quantified datasets of an instance of the experience. These mechanics include, for example, rules, teams, versus, orders of operation, timing systems, courses, checkpoints, challenges, routes, gamespace boundaries, triggers, start and end conditions, completion and failure, or other conditional gamification mechanics yet defined.

Preferably, the unique identifiers communicate with the experience control system in real time via data transmissions. These data transmissions allows the experience control system to track, capture, record, and store a quantified dataset of each participant's experience results as their own unique instance of the experience.

The real time physical reality immersive experience at times may use one or more experience interaction devices for each participant. Experience interaction devices are defined as a physical technical device (e.g., affixed to a participant, carried by a participant, or apparel worn by the participant). Each participant may be given an experience interaction device for the experience. At the conclusion of an instance of the experience, participants have their experience interaction device removed so that the experience interaction device can be reused for future participants. In a preferred embodiment, at least one of the experience interaction devices is provided by a position-sensing or space-sensing mobile device. The experience interaction devices and unique identifiers utilized by the real time physical reality immersive experience may or may not be integrated into a single physical technical device.

Experience interaction devices allow participants, non-participants, external participants, and the experience itself to interact with the experience and receive real time feedback of their respective instance of the experience.

Experience interaction devices perform many functions, including, but not limited to, audio feedback such as sound effects, video feedback such as real time clocks displaying timing information related to gamification mechanics, simulated reality extensions, mixed augmented reality, user interfaces and control mechanisms for taking actions such uses as selecting and using expendables, external interactions with experience, progression of the experience, and/or any other mechanisms with which a participant, non-participant, external participant, and the experience itself could interact with and receive real time feedback of their respective instance of the experience.

Preferably, the experience interaction devices are controlled by the experience control system in real time via data transmissions. The experience control system can control each experience interaction device independently, and collectively as a group of experience interaction devices, simultaneously. Quantifiable data generated by experience interaction devices are incorporated as part of their respective associated participant's, non-participant's, external participant's, or game state's quantified dataset of their respective instance of the experience.

Some experience interaction devices may be a physical technical device that is affixed to or within each participant, or apparel worn by the participant, or held by the participant, during the experience. These types of experience interaction devices are defined as unique participant experience interaction devices. Participants may utilize multiple independent unique participant experience interaction devices simultaneously during an instance of the experience that may allow for additional quantifiable data to be generated. Multiple independent unique participant experience interaction devices could be designed to function as a group, or sub group, of other multiple independent unique participant experience interaction devices to facilitate possible gamification mechanics.

When unique participant experience interaction devices are utilized, each participant is associated with these types of experience interaction devices before the start of the experience if they don't already have the requisite experience interaction devices associated with them for the version of the experience they're about to participate in. At the conclusion of an instance of the experience, participants may have these experience interaction devices removed, some of which may be recycled and reused for future participants.

When utilized, quantifiable data generated by a participant's unique participant experience interaction devices are incorporated as part of the participant's quantified dataset of an instance of the experience. These types of experience interaction devices interact with data capture mechanisms in real time via data transmission during an instance of the experience to facilitate their designed functions.

Unique participant experience interaction devices perform many functions, including, but not limited to, audio feedback such as sound effects directly resulting from an action taken by the associated participant, video feedback such as a real time point total of the participant's accumulated points during the instance up through present, simulated reality extensions, mixed augmented reality, user interfaces and control mechanisms for taking actions such uses as selecting and using expendables, tactile and kinesthetic haptic feedback to the participant, external interactions with experience during a participant's instance, and/or any other mechanisms with which a participant could interact with the real time physical reality immersive experience.

In implementations where both unique participant experience interaction devices and physical device unique identifiers are utilized by the real time physical reality immersive experience, these devices may or may not be integrated into a single physical technical device.

Looking at the example illustrated by FIG. 3, an experience may include checkpoints. In some embodiments, every checkpoint contains 1 or more challenges delineated into distinct pathways. For example, one checkpoint could have a 4 ft wall, 8 ft wall, and 12 ft wall delineated into 3 distinct pathways, one of which must be scaled. For conceptual purposes, an example course could have 25 checkpoints, each with 3 different challenges, one of which must be chosen to complete, or attempt to complete, at each checkpoint. In this example, since participants are presented with 3 different choices at each checkpoint, being required to choose one of the three choices, there are over 847 billion possible different completion combinations through this conceptual course.

Systems of the invention may include data capture spots. Data capture spots may be any combination of technology, software, or hardware systems that interacts with the unique identifiers, experience interaction devices, and experience control system in real-time via data transmissions. A participant's unique identifier or experience interaction device passing through these data capture spots allows the experience control system to track, capture, record, and store a quantified dataset of the participant's instance of the experience. Tracked, captured, recorded, and stored data and actions may include, but is not limited to, physical movement within three dimensional space, selected choice from a plurality of choices, physiological data of the participant, timestamps, and participant interactions with the experience systems and mechanisms. Courses may contain start and finish data capture spots. Checkpoints may contain data capture spots. A challenge at a checkpoint may contain a data capture spot. Additional data capture spots may exist anywhere along a course to capture additional data, such as, within a challenge to track the completion or failure of participants who attempt the challenge.

Experiences according to the invention may be user-defined. Participants make a conscious choice as to which challenge they choose to complete, or attempt to complete, or in the case of routes, which distinct route to take, at each checkpoint as they traverse the course. For example, one checkpoint could have a 4 ft wall, 8 ft wall, and 12 ft wall delineated into 3 distinct pathways, one of which must be scaled.

Each checkpoint and challenge uses its own data capture spot to track, capture, record, and store each participant's individual choices and actions taken at every checkpoint and chosen challenge during the experience. The analysis of each participant's quantified dataset of an instance of the experience determines which of the nearly limitless completion combinations they traversed the course with.

In certain embodiments, a real time physical reality immersive experience uses a points system. The points system is designed to quantify the nearly limitless course completion combinations and actions taken during an instance of the experience in an easy to use and understand format.

Individual point values are assigned to each choice and some actions. Point values can be positive or negative values. At the conclusion of a participant's instance of the experience, the experience control system analyzes the participant's quantified dataset of the instance to calculate their accumulated points. For example, using the conceptual checkpoint above, the 4 ft wall may have a 500-point value, the 8 ft wall may have a 1,500-point value, and the 12 ft wall may have a 3,000-point value. A participant who chooses to scale the 4 ft wall would receive 500 points. A participant who chooses to scale the 8 ft or 12 ft wall would receive 1,500 or 3,000 points respectively.

The real time physical reality immersive experience at times may utilize real time experience modifiers. Real time experience modifiers are defined as technical, physical, mechanical, digital, software, hardware, and/or any other type of system used to affect the experience in real time as participants traverse a course. These modifiers may also be utilized to affect a participant's results of an instance of the experience. Real time experience modifiers are controlled in real time by the experience control systems, version control systems, and/or master control system via data transmissions. Examples include, but are not limited to, completion and/or failure of challenges, bonuses, combos, expendables, power-ups, causality, and/or peripherals, each further detailed below.

Data capture spots may be utilized within a challenge to track, capture, record, and store whether a participant successfully completed the challenge, or if they failed at their attempt. Completion or failure of challenges allow for further variables, such as multiple point values for a single challenge, that are used within the above described points system and the below described result and ranking systems, to more accurately quantify datasets of participant's instances of the experience. For example, one challenge could be a balance beam over a pool of water. If a participant successfully crosses the balance beam without falling into the pool, they will be able to pass through the data capture spot on the completion side of the challenge, accessible only by successfully completing the challenge. If a participant falls into the water before fully crossing the balance beam, thereby unsuccessfully completing the challenge, they would exit the pool through a separate exit on the side of the pool and pass through a separate data capture spot (failed attempt) before continuing along the course. Challenges with a failure component only allow participants to pass through one of these data capture spots; either the successful or failed data capture spots.

In some embodiments, an experience will include a bonus system. Bonuses are defined as numerical point values assigned to actions taken and/or meeting certain conditions during an instance of the experience. Bonuses may be awarded to participants during and/or after completion of an instance of the experience. Bonuses awarded are incorporated into the results of the participant's instance of the experience in which they are awarded. For example, a ‘fastest time of the day’ bonus could be awarded to the participant who completes an instance of the experience with the shortest elapsed time each day.

Combos are a sub class of bonuses, defined as a specific chronological sequence of choices made and/or actions taken by a participant during an instance of the experience. Combos are considered performed when a participant has completed the specific chronological sequence during an instance of the experience. To illustrate combo, the above-described checkpoint (consisting of challenges of a 4 ft wall, 8 ft wall, and 12 ft wall delineated into 3 distinct pathways) could be followed by a checkpoint with the above-described challenge of a balance beam over a pool of water. A ‘high-scaling balancer’ combo could be awarded to participants who choose to scale the 12 ft wall and then successfully complete the balance beam challenge.

Additional and alternative features that may be provided by systems and methods of the invention include expendables, power-ups, causality, rankings, experience-point systems, and other gamification features.

Expendables are defined as physical items, digital goods, or similar mechanisms that participants may use at will during an instance of the experience to modify their instance of the experience that last for a duration of time during that instance. All digital goods expendables or similar mechanisms are stored in each participant's experience account. Expendables may be cumulative and multiple different expendables may be active simultaneously. For example, a ‘challenge redo’ digital expendable could allow a participant to use it to re-attempt a failed challenge immediately upon failing that challenge.

Participants acquire expendables through a variety of means, including, but not limited to, earning them by completing instances of the experience, being awarded them as prizes, purchasing them with real and/or virtual currency, as additional rewards for performing combos, or by any other means of possible distribution or acquisition.

Power-Ups are a sub class of expendables defined as mechanisms that modify a participant's instance of the experience in real time during the participant's instance of the experience, that last for a duration of time during that instance. Power-Ups can be activated and/or triggered by choices made, actions taken, combos performed, expendables, or by any analyzable means of a participant's quantified dataset of the instance of the experience. Power-ups may be cumulative and multiple different power-ups may be active simultaneously. For example, a ‘double points’ power-up could be triggered for a participant who performs the above described ‘high scaling balancer’ combo. This conceptual power-up would modify the participant's instance of the experience by doubling the points received from their next challenge along the course.

Causality may be used to modify and/or enhance a participant's instance of the experience. Causality is defined as two chronological events, where the second is a consequence of the first. The first event is the cause, which leads to the second event, which is the effect. As it relates to causality, an event is defined as any quantifiable and/or analyzable event, or the analysis of quantifiable data or events. For example, if a single participant makes the same choice at a specific checkpoint during every instance of the experience, the experience control system can modify the points the participant receives to be lower than the standard points the choice is worth for future instances of the experience for that participant. In this example, the effect (the second event) of the participant making the same choice repeatedly (the first event, the cause) is a negative reinforcement of point reduction.

Some embodiments include a results and rankings system. At the conclusion of each participant's instance of the experience, their results and rankings are calculated using the points accumulated, the choices made, and the actions taken during their entire instance of the experience. The primary ranking system relies on points accumulated during the experience. This primary ranking system places participants in a descending order, with the participant accumulating the most points placing first, and the participant accumulating the least points placing last. This system is updated in real time whenever a participant completes an instance of the experience. Additional result and ranking systems exist beyond the above-mentioned primary ranking system. These additional systems calculate their respective results and rankings utilizing any possible mathematical formula, with any combination of participant's quantified data as a portion of the formula's dataset and/or variables, including, but not limited to, physical movement within three dimensional space, selected choice from a plurality of choices, physiological data of participants, timestamps, and participant interactions with the experience systems and mechanisms. These additional result and ranking systems are updated in real time whenever a participant completes an instance of the experience.

Some of these additional result and ranking systems are designed as checklist and achievement systems to allow participants to analyze their complete experience history in a variety of ways and provide further game-like strategy and engagement within the real time physical reality immersive experience.

Participant result and ranking systems based on points accumulated, conscious choices made, and actions taken by each participant instead of a participant's elapsed time create a game-like strategy within the real time physical reality immersive experience.

Experience Points (XP) and levels may be included. Each participant's unique experience account tracks, captures, records, and stores their complete real time physical reality immersive experience history. These accounts also track, capture, record, and store a participant's cumulative points received from each instance of the experience they complete. A participant's cumulative total of points received from all completed instances of the experience is called XP, which stands for accumulated experience points. XP may be segmented into various types, including, but not limited to, total, yearly, date range, version, and/or any other means of possible segmentation. Each type of XP may be further segmented into numerical ranges. These ranges are called levels. The levels for each type of XP may have different ranges for their respective levels.

For example: (1) Participant 1 completes their first instance of version A of the experience, receiving a total of 93,000 points. Upon completion of this instance of the experience, participant 1's Total XP is 93,000 and their Version A XP is 93,000. (2) Participant 1 completes their second instance of version A of the experience, receiving a total of 102,000 points. Upon completion of this instance of the experience, participant 1's Total XP is 195,000 and their Version A XP is 195,000. (3) Participant 1 completes their first instance of version B of the experience, receiving a total of 99,000 points. Upon completion of this instance of the experience, participant 1's Total XP is 294,000, their Version A XP is 195,000, and their Version B XP is 99,000. (4) Furthermore, if Total XP and Version A XP had ranges of 100,000 points, and Version B XP had ranges of 50,000 points, participant 1's Total XP Level is 3, their Version A XP Level is 2, and their Version B XP Level is 2.

The invention may use XP and levels in a variety of ways, including, but not limited to, causality, unlocking of new challenges at checkpoints in future instances, gamification of frequency of instances, and/or any other potential use within the experience yet defined.

The real time physical reality immersive experience at times may utilize pre-experience modifiers. Pre-experience modifiers are defined as technical, physical, mechanical, digital, software, hardware, and/or any other type of system used to affect the experience prior to a participant starting an instance of the experience. These modifiers may also be utilized to affect a participant's results of an instance of the experience. Pre-experience modifiers are controlled by the experience control systems, version control systems, and/or master control system via data transmissions. Examples of pre-experience modifiers include, but are not limited to, experience modes, classes, and/or peripherals, each further detailed below.

Each participant chooses which, if any, pre-experience modifiers they would like their instance of the experience to utilize. Some pre-experience modifiers allow participants who have chosen different combinations of pre-experience modifiers for their instances to be completed simultaneously. Other pre-experience modifiers may require all participants completing their instances during the time these pre-experience modifiers are active to be utilizing this same combination of pre-experience modifiers. Pre-experience modifiers may include experience modes, classes, or both.

Experience modes are a sub class of pre-experience modifiers defined as operational protocols with which the experience control system utilizes to modify and control the experience to facilitate affecting a participant's instance of the experience, for that specific instance. Experience modes do not create a new version of the experience, only a modified experience of the version for a specific instance.

Experience modes include, but are not limited to, standard participant experience, participant versus experience, participant versus participant, participant versus team, team versus team, team versus experience, individual time trial, team time trial, and/or any possible operational protocols utilized to modify and control a participant's instance of the experience. For example, an experience mode called physical individual time trial could modify the experience, such as prohibiting participants from choosing any non-physical challenge from a plurality of challenge choices, to facilitate participants running through the course in an attempt to complete the course in the shortest elapsed time.

Classes are a sub class of pre-experience modifiers defined as participant archetype protocols with which the experience control system utilizes to modify and control a participant's instance of the experience. Prior to starting an instance, a participant may choose if allowed, to select a class to complete the instance as. Modifications of the instance of the experience include, but are not limited to, limiting available challenge choices at checkpoints, point modifiers deviating from standard, time limits to complete certain aspects of the experience, penalties for specific actions taken by the participant, and/or any other means of modifying an instance of the experience from its standard of not utilizing a class. For example, a class called athlete could prohibit the participant from choosing any challenge that did not contain a physical or dexterous activity.

As discussed above and throughout, systems of the invention may include one or a number of peripherals. Peripherals may be used as either and/or both pre-experience and real time experience modifiers. Peripherals are defined as physical technical or mechanical devices that participant's may utilize to interact with the experience. Interactions include, but are not limited to, completing challenges, performing combos, using an expendable, activating a power up, and/or any other means of possible interaction with the experience. A Participant at times may utilize multiple peripherals simultaneously.

Peripherals utilize unique identifiers to distinguish individual peripherals from each other. Peripherals also utilize technology, software and/or hardware systems, to communicate with the experience control system in real time via data transmissions. These unique identifiers and technology utilized by peripherals allow the experience control system to track, capture, record, and store a quantified dataset of a participant's interaction between themselves, the peripheral, and the experience during a participant's instance of the experience. Quantified data includes, but is not limited to, trajectory, velocity, speed, impact, force, rotational direction, timestamps, and/or any other possible data that can be quantifiably tracked, captured, record, and stored. The experience control system can control each peripheral independently, and/or collectively as a group of peripherals, simultaneously.

For example, a challenge could consist of a participant throwing a ball at a target. The ball is considered a peripheral. The experience control system can track, capture, record, and store quantifiable data of a participant throwing the ball at the target, such as detecting a successful strike of the ball on the target.

Systems of the invention may include or provide a structure. In some embodiments, the system includes a modular efficiently transformable assembly structure (METAS).

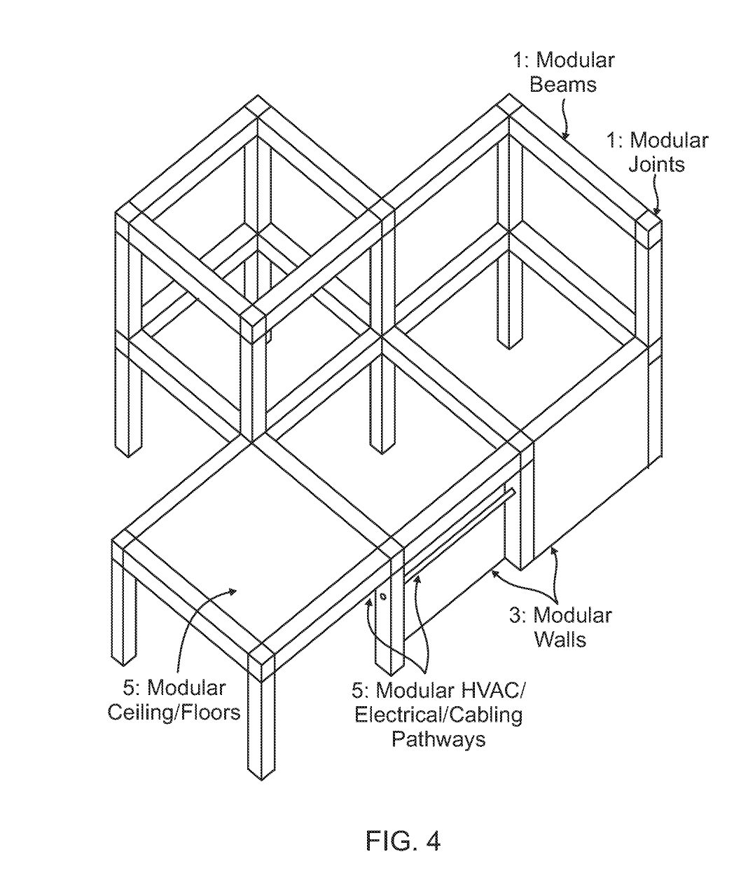

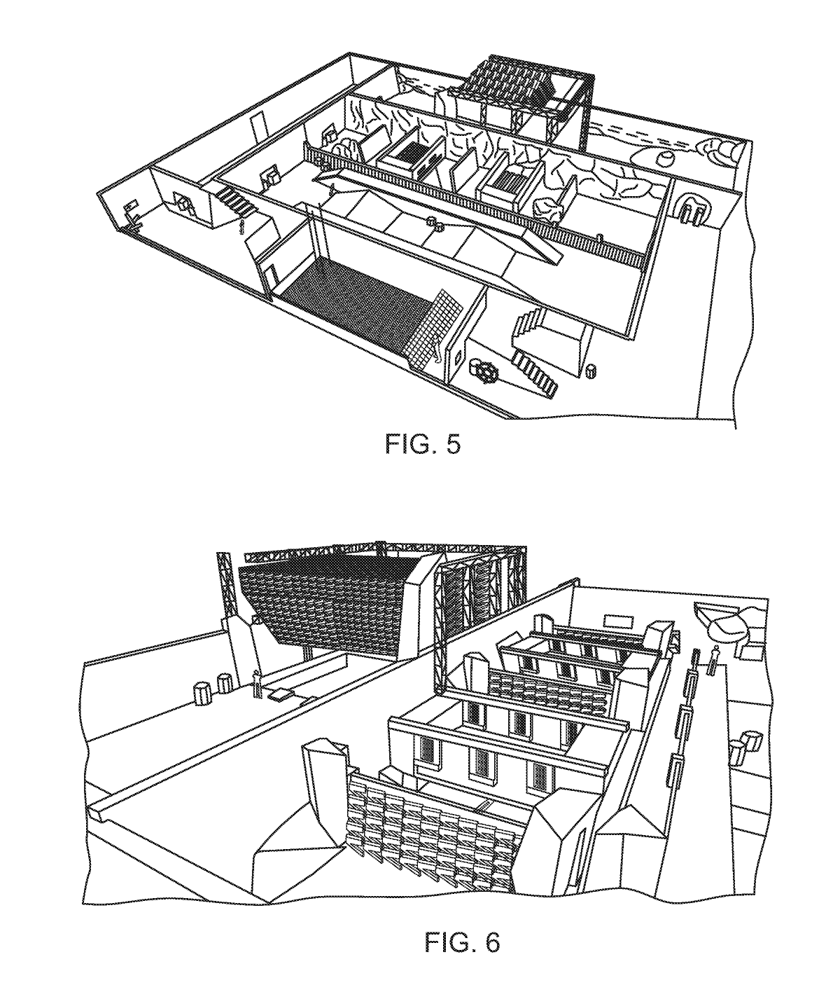

FIG. 5 shows a transformable structure, or METAS, according to certain embodiments. Systems of the invention use METAS to produce components of the experience. METAS allows the experience to be configured and reconfigured in a time and cost efficient manner. Modular components of the METAS system includes, but is not limited to, structural engineering components such as walls and beams, transformable components such as pocket doors and sliding panels, semi-permanent floors and ceilings, hinges, couplers, joints, braces, tracks, risers, stairs, HVAC, and/or any other possible structural and/or mechanical components of the system. FIG. 5 shows an example of hardware infrastructure components that may be easily assembled and reconfigured. Modular beam 1, connects to modular joint 2, framing modular wall 3, with modular ceiling/floor 4 and HVAC 5.

FIG. 6 gives a perspective view of a METAS. METAS may provide various components of the experience, including, but not limited to, courses, checkpoints, challenges, pathways, and/or any other possible components of the experience.

The real time physical reality immersive experience at times utilizes numerous technologies, production methods, processes, protocols, and other similar means to create a highly immersive experience for participants. Immersive is defined as providing stimulation to any combination of senses. Technology utilized to create this immersive experience includes, but is not limited to, scenic design, environment design and control, HVAC, game design, overarching stories, audio and video effects, special effects, lighting, METAS, non-participant people within experience, and/or any other possible means of immersing participants in the experience.

Components of the technology may be controlled by the experience control system in real-time via data transmissions; the experience control system can control this technology independently, and/or collectively as a group of technology, simultaneously. Some of the immersive experience technology communicate and/or interact with other components of the experience, such as a participant's unique identifier, to facilitate the ability to track, capture, record, and store a participant's quantified dataset of their instance of the experience. For example, a challenge could consist of a participant throwing a ball at a target. If the ball hits the target, a sound effect could be played through speakers within the challenge to provide an audio feedback to the participant relating to their individual action. As such it can be seen that systems and methods of the invention provide a highly controlled environment for engaging and rewarding experiences.

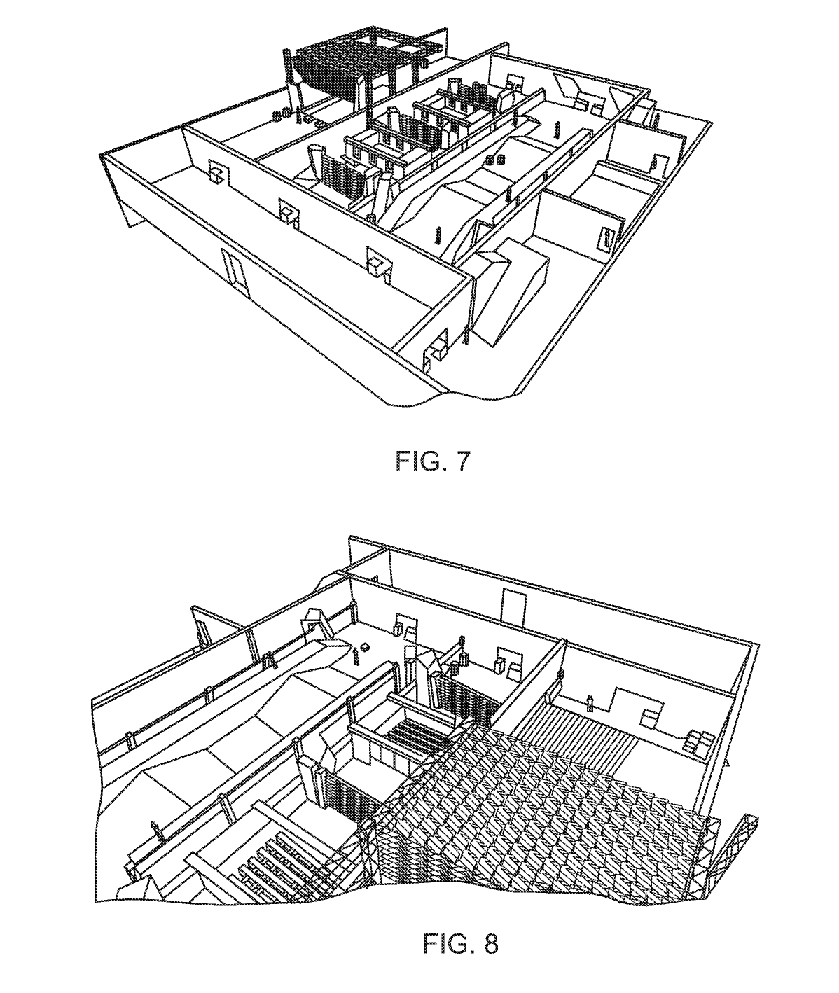

FIG. 7 gives another view illustrating a controlled environment as provided by a system of the invention.

FIG. 8 gives a detail view of a controlled environment.

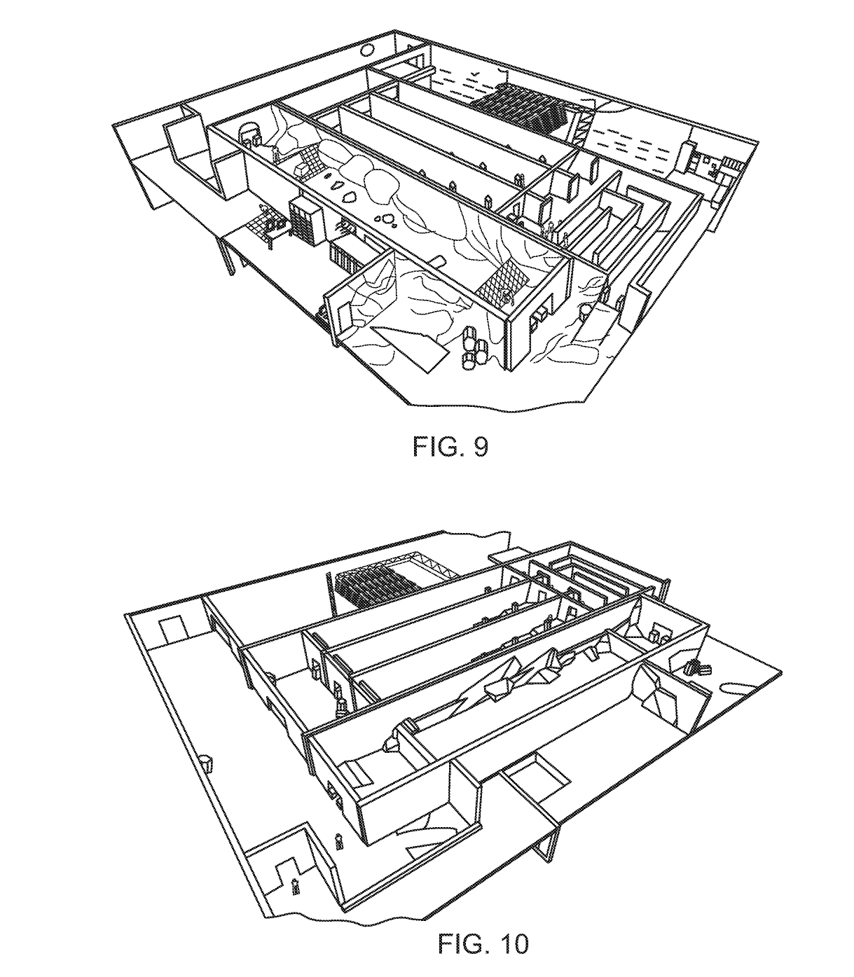

FIG. 9 illustrates a physical environment provided by the system.

FIG. 10 shows another possible environment provided by the invention.

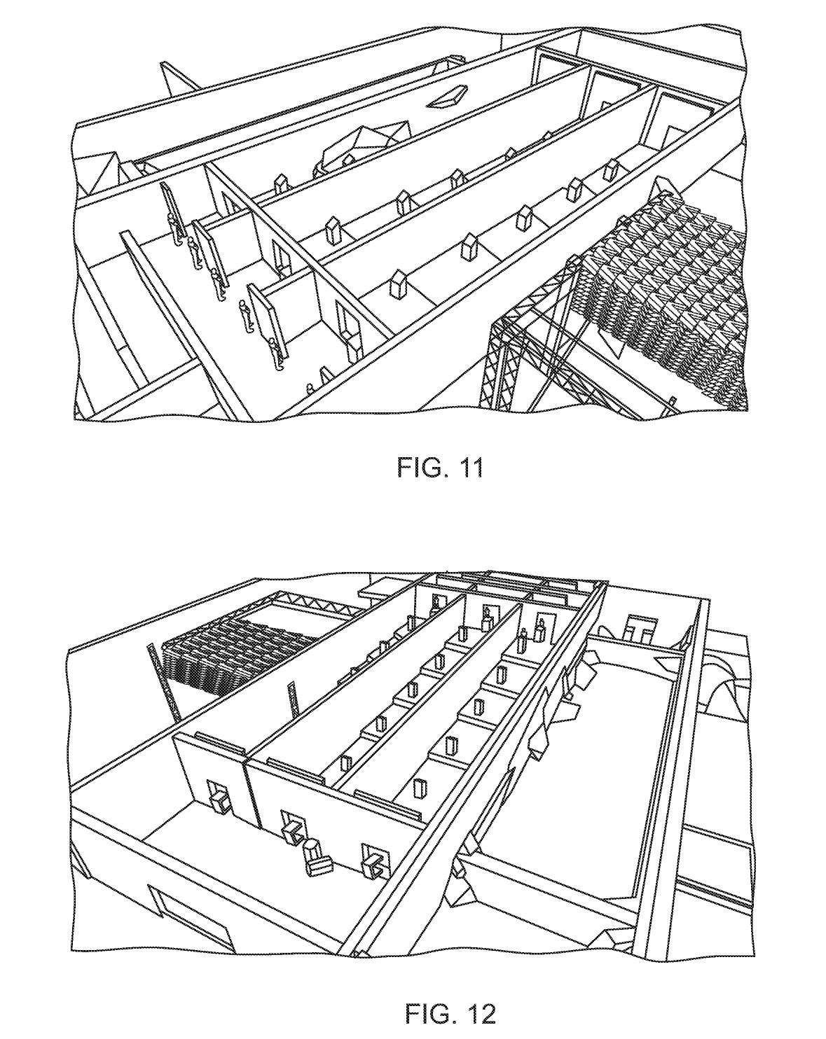

FIG. 11 shows a view of a physical environment to be used for gamified physical activity by people.

FIG. 12 gives another view of the environment shown in FIG. 11.

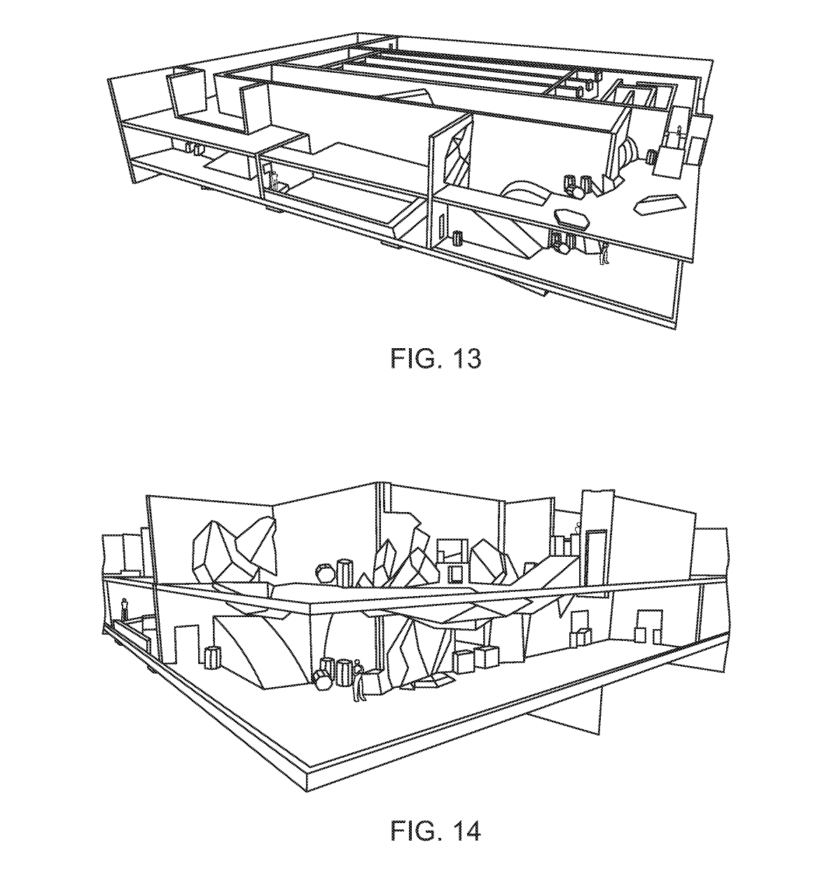

FIG. 13 gives another view of the environment shown in FIG. 11.

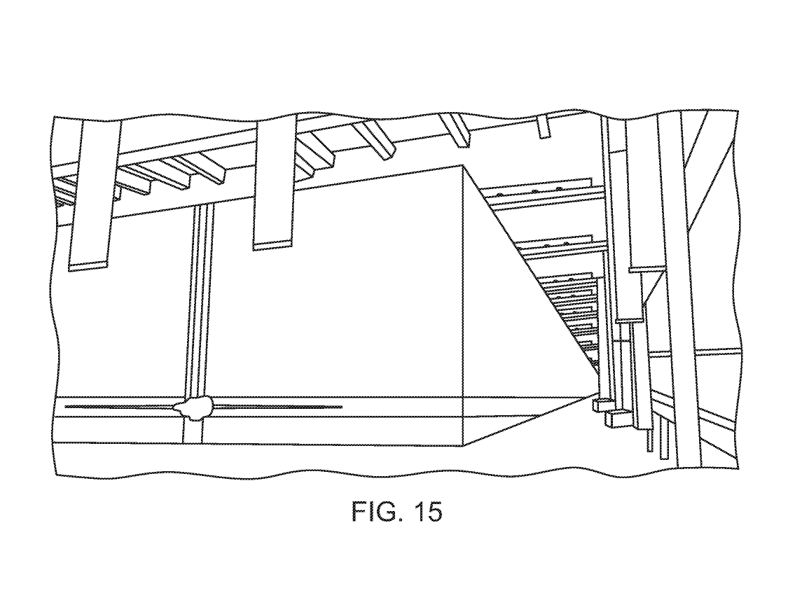

FIG. 14 gives another view of the environment shown in FIG. 11.

FIG. 15 illustrates an aspect of a physical environment provided by a system of the invention from a perspective of a participant.

Together, FIGS. 7-15 show detailed views of exemplary controlled environments. The real time physical reality immersive experience at times utilizes HVAC and other technology systems to control the environment of the experience. Controlled environmental components include, but are not limited to, temperature, humidity, pressure, airflow, precipitation, chemical elements, smells, and/or any other possible environmental components. These technology systems allow each course, checkpoint, and challenge to have its own environment design and configuration. These technology systems are controlled by the experience control system in real time via data transmissions; the experience control system can control these systems independently, and/or collectively as a group of systems, simultaneously.

For example, a checkpoint could consist of two challenges, the first challenge requiring participants to cross a mountain pass, the second challenge requiring participants to traverse an underground cave. The experience control system can control the temperature and airflow of each challenge independently and simultaneously, such that the first challenge is cold and windy, and the second challenge is damp, cold, and has a stagnant airflow.

The real time physical reality immersive experience may use fiction or non-fiction stories, themes, narratives, characters, or similar means to immerse participants in the experience. Presenting, representing, and conveying these means are achieved utilizing a variety of methods, including, but not limited to, visually, aurally, utilization of scenery, environment design and control, technology, and/or any other possible methods of presenting, representing, and conveying these fiction and/or non-fiction stories, themes, narratives, or similar means to participants. Some of these means may be controlled by the experience control system in real time via data transmissions; the experience control system can control these means independently, and/or collectively as a group, simultaneously.

For example, a version of the experience could have a jungle setting, theme, and story consisting of a fictionalized native population of the jungle setting as its characters of the story. In this example, all components of the experience would fit within this created world, including, but not limited to, the course, checkpoints, challenges, scenic design, environment design, fictionalized characters, participant interactions with the experience, and/or any other components necessary to create this immersive experience.

In certain embodiments, systems and methods of the invention include non-participant people within the experience. These non-participating people facilitate various aspects of the experience, including, but not limited to, participant control, immersive experience enhancement, conveying of the overarching story, as means of experience interaction, awarding bonuses, and/or any other possible uses yet defined. Non-participating people are recruited, trained, and implemented within the experience by the operations team.

The real time physical reality immersive experience is designed to allow continuous progression of the experience. Continuous progression of the experience is defined that each version of the experience will change over time. Components that may change in each version of the experience include, but are not limited to, the course layout, checkpoints, challenges, point values, immersive experience components, and/or any other components with which the experience may be progressed. Progression of a version of the experience does not create a new version of the experience, only an updated (modified) experience of the version.

Progression occurs according to a progression schedule, which is defined as a rate of change over time between each progression of a version of the experience. Multiple progression schedules may be utilized simultaneously to progress various components of a version of the experience independently. For example, version A of the experience could have a one year overall progression schedule. This would signify that version A of the experience changes each year. Using the example above, if the first year of version A of the experience has a jungle setting, theme, story, and experience; the second year of version A of the experience could have an island setting, theme, story, and experience.

The real time physical reality immersive experience at times utilizes media capture equipment. Media capture equipment is defined as technology, software and/or hardware systems and/or devices, used to capture, record, and store various types of media, including, but not limited to, cameras, microphones, accessories, and/or the technology utilized to control such technology.

This media capture equipment is utilized to capture, record, and store a robust media library of each instance of the experience, including, but not limited to, photographs, videos, audio, and/or any other possible forms of media. This equipment is controlled by the media control system in real time via data transmissions; the media control system can control this equipment independently, and/or collectively as a group of equipment, simultaneously. The media control system communicates with the experience control system in real time via data transmissions.

The real time physical reality immersive experience at times utilizes real time media tagging. Media tagging is defined as an automated process of identifying characteristics of a segment of media and applying a set of quantified data to the segment. Quantified data characteristics include, but are not limited to, media type, timestamps, unique participants included in segment, contents, location data of where media was captured, and/or any other quantifiable data that can be tracked, captured, recorded, and stored for a segment of media.

The media control system controls real time media tagging. This system communicates in real time via data transmissions with all other technical systems of the experience, including, but not limited to, the experience control system, version control system, master control system, media capture equipment, data capture spots, unique identifiers, experience interaction devices, environment control technology, and/or any other technical system of the experience.

The media control system utilizes these media tags to facilitate a variety of functions, including, but not limited to, cataloging the media library, querying the media library, facilitating the broadcast of live streams of the media, and/or any other possible functions. An example of an automated process of media tagging of participants during an instance of the experience is as follows: (1) Challenge A has a video camera affixed at it, recording video of the challenge; (2) The video camera is controlled by the media control system; (3) The challenge has two data capture spots, one at the starting point of the challenge, one at the finishing point of the challenge; (4) As a participant's unique identifier passes through each of the challenge's data capture spots, a timestamp of the event is created; (5) The media tagging control system, utilizing the timestamp data of these two events, tags the segment of the challenge's video file during which the participant traversed through the challenge with the participant's experience account number.

The real time physical reality immersive experience at times may broadcast live media streams of the experience to various distribution channels and devices, including, but not limited to, online websites and applications, mobile applications, satellite and television broadcasts, and/or any other possible forms of distribution. Live broadcast streaming of the experience is controlled by the streaming control system, which is a technical system of software and/or hardware systems that controls the distribution of data of the experience to various distribution channels and devices. The streaming control system can simultaneously stream to multiple internal and external distribution channels and devices. For example, the streaming control system at times may broadcast an internal stream of data, such as a CCTV feed, to various distribution channels and devices connected to a location of the experience, such as the operator control room; while simultaneously broadcasting a live stream of an instance of the experience through a website application for external spectating of the instance of the experience.

The real time physical reality immersive experience at times may stream results of instances of the experience in real time as instances are occurring to various distribution channels and devices, including, but not limited to, social media platforms, web applications, mobile applications, media broadcasts, and/or any other possible forms of distribution. Real time results streaming of the experience is controlled by the streaming control system. Real time results streams at times may be synced with live media broadcast streams of the experience to form a combined single steam of media and results.

In some embodiments, the real time physical reality immersive experience is designed to allow external interactions with the experience. External interactions are defined to include, but are not limited to, actions, mechanisms, technical systems of the experience, and/or any other possible component of the experience, which at times may be controlled remotely by an external non-participating person.

External interactions are controlled by the external interaction control system, which is a technical system of software and/or hardware systems that controls external interactions with the experience. The external interaction control system communicates with other systems of the experience in real time via data transmissions. For example, a challenge could require a participant to throw a ball at a moving target. At times, the movement pattern of this target would be controlled by the experience control system. At other times an external non-participating person, such as a participant's friend, could control the movement pattern of this target through the external interaction control system. In this scenario, the non-participating person would utilize a digital application or physical device consisting of a user interface and control mechanisms to control the movement pattern of the target, thereby facilitating the external interaction with the experience.

All people interacting with the experience externally utilize their own experience account, which will track, capture, record, and store the person's complete history of their external interactions with the experience.

Virtual currency and synthetic economy may be included. Virtual currency is defined as electronic money that acts as an alternative currency used to facilitate the exchange of physical and/or virtual goods. A single virtual currency may be utilized for all versions of the experience, or certain versions of the experience may utilize its own virtual currency.

Synthetic economy is defined as an emergent economy, existing in a persistent reality, exchanging physical and/or virtual goods. As it relates to the real time physical reality immersive experience, the persistent reality is the experience, its participants, and non-participating people externally interacting with the experience. A single synthetic economy may emerge encompassing all versions of the experience, multiple synthetic economies may emerge for all versions of the experience, and/or individual synthetic economies may emerge for each version of the experience.

As discussed throughout, the invention generally relates to the gamification of physical actions taken by a person, which may preferably be accomplished through the use of a system that includes a space-sensing, position-sensing mobile device. Gamification is defined as the application of typical elements of game playing (e.g. point scoring, competition with others, rules of play, game mechanics) to other areas of activity and/or non-game contexts.

Multiple components of the real time physical reality immersive experience detailed within this disclosure, including, but not limited to, physical medium, a plurality of choices, user defined choices and actions, the points system, experience modifiers, causality, results and rankings, XP and levels, continuous progression of the experience, external interactions with experience, and/or any other components of the experience, create a game-like strategy within the experience that constitutes gamification of actions taken in physical reality.

Some versions of the real time physical reality immersive experience at times may utilize simulated reality extensions. Simulated reality extensions are defined as digital mediums that people may utilize to interact with the experience, and/or complete instances of the experience, in a non-physical way, including, but not limited to, video games, mobile games, web and mobile applications, and/or any other possible method of simulated reality interaction. For example, a version of the experience could be replicated as a simulated reality video game. Participants could complete instances of the experience in real time physical reality, and/or in the simulated reality.

In certain embodiments, systems and methods of the invention provide simulated physical reality immersive training environment (SPRITE) technology. SPRITE technology uses Mixed Augmented Reality (MAR) within a real time physical reality immersive experience to create an interactive, multi-sensory immersive environment. In some embodiments, SPRITE technology enhances a game or sporting event experience that may have, for the users, a primarily recreational or physical fitness purpose. However, additional and alternative embodiments of the invention relate to use of systems and methods of the invention for training personnel such as in a military, law enforcement, or emergency first-responder setting (hereinafter “military”). Using SPRITE technology, systems and methods of the invention provide a non-linear, immersive training environment that provides military training that is unparalleled in flexibility and realism.

SPRITE uses gamification technology to enhance these immersive training environments while simultaneously allowing the system to control levels of complexity and realism presented to military personnel in real time. SPRITE may incorporate haptic feedback—both tactile and kinesthetic—in combination with gamification techniques to improve a participant's exteroception and performance.

SPRITE may incorporate use of peripherals, such as the Multiple Integrated Laser Engagement System (MILES) or similar, as well as other technology, to enhance the overall system. Other technology will include biometric tracking for each individual Solider that will capture their physiological data, such as heart rate, blood pressure, perspiration, O2 levels, and other physiological data to be defined, in real time within SPRITE.

SPRITE may provide comprehensive After Action Review (AAR) assessments of any training or rehearsal system to date through the use of big data capture, storage, and analysis. The AAR system will facilitate advanced mission planning, complex scenario analysis, individual Solider and unit performance improvements over time, and countless other data driven assessments.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

### Appendix 1: Military Training

A SPRITE system of the invention may support methods and technologies discussed in sections such as 4.2.6 & 4.2.8 of the Army Research Laboratory Broad Agency Announcement for Basic and Applied Scientific Research issued by U.S. Army Contracting Command—Aberdeen Proving Ground, Research Triangle park Division (Research Triangle Park, N.C.) (164 pages) (hereinafter “Mod2_ARL_BAA_revsept13.pdf”), the entire contents of which are incorporated by reference for all purposes. For ease of reference, those sections and introductory section “e. CORE COMPETENCY 4: HUMAN SCIENCES” of that document are appended here.

e. Core Competency 4: Human Sciences

(From pages 63-64 of Mod2_ARL_BAA_revsept13.pdf)

ARL plans, manages, and conducts a comprehensive, multi-disciplinary program of scientific research directed toward defining human performance in sensory, perceptual, cognitive, and physical domains, utilizing experimental and modeling approaches from disciplines such as psychology, cognitive and computer science, neuroscience, human factors engineering, and systems engineering. ARL research provides the scientific foundations for application to militarily relevant domains such as human systems integration, task performance modeling, and anthropometric biomechanical modeling. The end goal is to guide optimal design of human system interaction in operational environments. ARL also conducts research associated with training technologies, and advanced distributed simulation, including adaptive and intelligent training technologies, virtual human research, immersive learning, synthetic environments, and training application domains such as medical, dismounted Soldiers, and embedded/live training.

### 4.1 Soldier Performance

(From page 64 of Mod2_ARL_BAA_revsept13.pdf)

### 4.1.1. Soldier Performance Research

Proposals are requested involving Soldier-oriented research and development (R&D) that advances and improves human factors design principles and guidance for enhancing Soldier and small team sensory (e.g., auditory, visual, and tactile), perceptual, cognitive, and physical performance while providing the materiel development community with the information necessary for effectively designing systems that are best suited to the operator, maintainer, or trainer. Proposals for technology for collecting sensory, cognitive and physical performance data (including biomechanics data) in field environments are also requested. Results of studies will be used to quantify trade-offs between the benefits of providing new technology and the cost to the dismounted Soldier of having and using that technology.

### 4.2 Simulation and Training

(From page 65 of Mod2_ARL_BAA_revsept13.pdf)

### 4.2.1. Adaptive and Intelligent Training Technologies:

Proposals are requested to design, develop, apply, and evaluate artificially-intelligent agent technologies (e.g., computer-based tutors, virtual humans, process agents and authoring tools/methods) to enhance training effectiveness and reduce associated training support costs. The goal of this research is to enhance the realism, adaptability and decision-making skills of artificially-intelligent computer-based tutors and virtual humans to support one-to-one and one-to-many training experiences where human support is limited, impractical, or completely unavailable. Technical challenges include the development/application of intelligent agents that can adapt in complex, ill-defined domains; understanding natural language in multi-sided conversations with trainees; rapid authoring of effective computer-based tutors for individuals and teams, and realistic virtual humans. Anticipated capabilities include computer-based tutors on par or better than expert human tutors and realistic virtual humans that are so visually and cognitively realistic that they are indistinguishable from humans. These capabilities will serve to provide enhanced “self-directed” learning while at the same time reducing associated training support costs.

### 4.2.6. Training Application Environments: Ground

(From pages 68-69 of Mod2_ARL_BAA_revsept13.pdf)

4.2.6.1. Embedded Simulation and Training for Combat Systems and Vehicles: Embedded Training (ET) is a capability designed into a Ground Combat System (GCS) and Dismounted Soldiers (DS) that enables the GCS and DS to provide necessary environmental and system feedback to train individuals, crews and units, and enhance operational readiness using the system's operational equipment. Having a training capability integrated within the system's operational equipment allows units to train anywhere and anytime, including while deployed. The goal is to enable more cost-effective training and mission rehearsal, on demand, whether at home station or deployed. ET must ensure maximum accessibility, as well as flexibility in execution of training for Soldiers and commanders. ET must have the capability to train without significant external support, and rapidly execute training with organic assets saving time for leaders to focus on execution and retraining. ET development may also aid in the areas of vehicle development and operational testing. The advent of emerging technologies such as enhanced visual systems, miniaturization, and computational processing power combine to support on-vehicle/on-location training that is realistic, low cost, and environmentally friendly. ET is a mandatory requirement for the Army's future systems and a requirement for other current force systems (e.g., Abrams, Stryker, and Bradley) as well as dismounted ground Soldier systems. The primary focus of research in this area is to mitigate the technology risk for current and future GCS by providing a technology demonstration on current force systems, with the goal of accelerating ET into the current force by facilitating the integration of earlier spirals of ET into the current force. Pacing technologies include, but are not limited to: embedding training and mission rehearsal on current force vehicles innovative methods for image generation and stimulated weapon sensors, methods to modify analog-based systems (brake, steering, direct view optics), embedded visual and display systems and mounted/dismounted interoperable ET environments.

### 4.2.6.2. Tactical Engagement Simulation Sensor Technology for Live Training

The Army has successfully fielded the Multiple Integrated Laser Engagement System (MILES) as a means of providing non-lethal, real-time casualty assessment for direct fire, force-on-force engagement exercises. Current research efforts will extend capabilities to include engagement training of Non Line-of-Sight (NLOS) and area effects weapons such as mortars and grenade launchers. Novel technical approaches are being sought to enhance or improve upon current MILES technology to include simulated tactical engagements of indirect fire weapons. Innovative approaches may include technology such as: a. Increasing optical link reliability between the MILES laser transmitter and detector that achieve probability of detection better than 95% under poor atmospheric conditions b. Methods that can compensate in real time for the effects of optical scintillation for improved link signal-to-noise c. Laser modulators that generate modulated bit output at 2.5 Gb/sec (or better) and consume less 50 mW of power d. Soldier mounted laser detectors that function in dual wavelengths (904.5 nm and 1550 nm) that have the potential for 4× reduction (or better) of the unit cost of current Avalanche Photo Detector (APD) technology e. Real time optical control to vary the laser transmitter output divergence angle f. Eye-safe laser range-finding that achieves a distance measurement accuracy of 10 m (or less), at a unit cost under $500, occupies a volume under 3 cm 3, and draws less than 200 mW of power g. Computer or image processing algorithms that can take 60 Hz input of video scenes and measure relative changes in angular rate with a minimum accuracy of 0.5 degrees such that it performs as an optical gyroscope during dynamic changes in the camera's field of view 4.2.6.3. Indoor Position, Location and Tracking for Live Training: ARL is interested in technologies that improve live training of simulated tactical engagements, particularly in urban terrain, where GPS signals may become degraded or obscured due to multi-path phenomena as Soldiers maneuver inside of buildings. During simulated tactical engagement training exercises, Soldier movements inside of buildings require accurate position/location measurement data that can be used for post training After Action Review (AAR) assessments. The technology approach to solve these challenges must be capable of determining the position/location of a dismounted Soldier with accuracy equal to or better than 30 cm (95%), have a unit cost less $1,000, occupy a volume under 100 cm 3, and have a battery life of up 72 hours (minimum) without changing or charging batteries. The need for infrastructure to support the technology must be minimal in terms of cost or maintenance, or ideally, none at all.

### 4.2.8. Training Application Environments Dismounted Soldier

(From pages 68-69 of Mod2_ARL_BAA_revsept13.pdf)

The Army needs advanced technology to provide dismounted Soldiers with fully immersive, simulation based training environments. These systems will provide the small unit leaders and individual Soldiers with a capability to conduct fully immersive, self-contained, simulation based training. ARL has an interest in researching, developing and demonstrating technologies and advanced techniques for virtual immersion as well as next generation Mixed Augmented Reality (MAR) environments for dismounted Soldiers. A core requirement of the system(s) is the ability to execute scenarios within immersive, virtual and MAR environments that allows advanced mission planning, analysis, and rehearsal. This environment should replicate the full spectrum operations to include non-kinetic social and cultural situations. We seek to explore methods of presenting 2D/3D virtual objects (representing various types of targets, fire and effects, friendly forces and opposition forces, civilians on the battlefield, vehicles, etc.) to the dismounted Soldier while operating both indoors and outdoors, on various types of live training environments. Additionally, the trainee would be capable of interacting with virtual targets, personnel, vehicles, etc. as though real. The objective is to create an interactive, multi-sensory, non-linear environment that provides the Warfighter with training that is unparalleled in flexibility and realism. The technology applied to solve these challenges should have the following characteristics or capabilities:

a. Low power man-portable CPU and Graphics processing hardware

b. Exploits the use of commercial gaming technology to provide immersive capabilities that leverages the advanced rendering and scenario development capabilities to present Soldiers with increasing levels of complexity and realism

c. Flexibility to incorporate the latest tactics, techniques, and procedures for constantly changing mission environments

d. Increased capabilities in field of view and resolution of head mounted display systems. Exploration of multi-modality for the man-machine interface

e. Augmented Reality (AR) for dismounted Soldier applications must provide a low cost, man-wearable system that uses minimal infrastructure, site preparation and set up time

f. Support interfaces, instrumentation & infrastructure in various types of military training environments (military operations on urban terrain sites, maneuver ranges, firing ranges, test ranges) as part of implementing realistic AR

Technologies include, but are not limited to: visual and display systems to include head mounted displays, computer systems, wireless tracking devices to include marker-less tracking technologies, natural locomotion, wireless video/audio transmission, MAR systems to include optically aided video odometry, accurate depth sensing and occlusion mapping, visual landmark detection technology; mission rehearsal, distributed AAR systems, and advanced synthetic natural environments.

### Appendix 2: Future Directions

### A2.1 Non Participant Progression

Non-participant game state may progress and exhibit actions/reactions independent of participants

### A2.2 Physical Object Stand-in

Physical objects—such as one or more robots—may stand-ins for a participant.

Imagine countries settling disputes with simulated war games in a physical environment that used robots instead of human soldiers, the simulated war game being controlled by an international peace keeping entity such as NATO or the international court system (the ‘experience operations team’ in these embodiments)

### A2.3 Remote Interactions

Adversarial (e.g. participant vs. participant) or cooperative interactions may occur between participants in remote locations using holographic, MAR, simulated reality extensions, and/or multi-sensory feedback technology to facilitate physical interactions despite participants being in remote locations relative to each other.

### A2.4 Physical Reality Game State

An embodiment of the system may apply object oriented programming theory to the gamespace and qualify and quantify every unique individual physical feature within the gamespace, both inanimate objects such as walls and animate objects such as humans, down to their smallest divisible unit. A real-time data capture and analysis system, in conjunction with a control system, may automatically gamify any quantifiable physical change over time that occurs within the gamespace, whether from a human's physical conscious action or an environmental action such as the decay of a radioactive element.

What is claimed is:

1. A system for gamification of actions in physical space, the system comprising:
a computing device comprising a processor coupled to a memory, wherein the system is operable to:
get data describing an action of a person within a space having a physical feature;
determine a relationship between the action and the physical feature; and
evaluate whether the determined relationship satisfies an objective stored in a program plan within the memory.

2. The system of claim 1, wherein the computing device comprises a mobile device having a display device and a sensing apparatus, wherein the mobile device is operable to track a three-dimensional motion of the mobile device within the space.

3. The system of claim 2, wherein the mobile device is further operable to create a map of the space, store the map in the memory, and display at least a portion of the map on the display device.

4. The system of claim 2, wherein the sensing apparatus is operable to capture at least 100,000 three-dimensional measurements per second.

5. The system of claim 4, wherein the mobile device is operable to use the three-dimensional measurements to create a digital, three-dimensional model of the space and the physical feature and store the model in the memory.

6. The system of claim 1, wherein the program plan defines a game in which a player must reach a series of checkpoints in the space, wherein the physical feature is one of the checkpoints and determining the relationship comprises determining whether the person is within a predetermined distance of the physical feature.

7. The system of claim 1, wherein the computing device comprises a mobile device comprising at least one sensor that senses a physical environment of the mobile device to create the data.

8. The system of claim 7, further comprising a server computer comprising a server processor system that performs the evaluating step.

9. The system of claim 8, wherein the server computer is operable to track progress of each of a plurality of participants through the program plan and provide a comparison of the progress of the various participants with each other.

10. The system of claim 7, wherein the sensor senses a three-dimensional shape of the physical environment.

11. The system of claim 10, wherein the mobile device is further operable to determine its own orientation within three-dimensional space of the physical environment.

12. The system of claim 11, wherein the program plan comprises a pre-defined game requiring a series of physical actions from a player.

13. The system of claim 11, wherein the program plan comprises a pre-defined military training exercise.

14. The system of claim 1, further comprising a structure dimensioned so that the action of the person may be performed within the structure, and wherein the physical feature is installed as part of the structure.

15. The system of claim 1, wherein the computing device is a mobile device operable to detect the physical feature and provide an augmented reality display showing a representation of the physical feature enhanced with digital imagery.

16. The system of claim 1, wherein the computing device is a mobile device operable to provide haptic feedback as part of the program plan.

17. The system of claim 1, wherein the computing device comprises a mobile device and the system further comprises:
a server computer operable to communicate with the mobile device; and
at least one peripheral device disposed within the space and configured to capture data within the space and transmit the data to the server computer,
wherein the server computer executes instructions provided by the program plan to process the data from the peripheral device and provide new information to the person through the person's use of the mobile device.

18. The system of claim 17, wherein the program plan defines a gaming or training exercise to be performed by a group of people within the space.

19. The system of claim 18, wherein the space is provided by a building comprising custom fixtures configured to correspond to the program plan, wherein the physical feature is provided by one of the custom fixtures.

20. The system of claim 1, wherein the program plan defines an exercise comprising a plurality of checkpoint objectives and a final object, and further wherein progress of people through the exercise is tracked by the computing device, wherein one of the checkpoints comprises determining whether a participant has reached the physical feature.

21. A method for the gamification of actions in physical space, the method comprising:
getting—using a computer system comprising a processor coupled to a non-transitory memory device—data describing an action of a person within a physical environment having a physical feature;
determining a relationship between the action and the physical feature; and
evaluating whether the determined relationship satisfies an objective stored in a program plan within the memory.

22. The method of claim 21, further comprising using a mobile device having a display and a sensing apparatus to track the three-dimensional motion of the mobile device within the physical environment.

23. The method of claim 22, further comprising:
creating, using the mobile device, a map of the physical environment,
storing the map in the memory, and
displaying at least a portion of the map on the display.

24. The method of claim 22, further comprising capturing at least 100,000 three-dimensional measurements per second via the sensing apparatus.

25. The method of claim 24, further comprising:
creating—using the three-dimensional measurements—a digital, three-dimensional model of the physical environment and the physical feature; and
storing the model in the memory.

26. The method of claim 21, further comprising determining whether the person is within a predetermined distance of the physical feature to determine if a player has reached one of a series of checkpoints in the physical environment according to a game defined in the program plan.

27. The method of claim 21, further comprising sensing—using a mobile device comprising at least one sensor—the physical environment to create the data.

28. The method of claim 27, wherein the evaluating step is performed by a server computer comprising a server processor.

29. The method of claim 28, further comprising:
tracking, using the server computer, progress of each of a plurality of participants through the program plan; and
providing a comparison of the progress of the various participants with each other.

30. The method of claim 27, further comprising sensing—using the mobile device—a three-dimensional shape of the physical environment.

31. The method of claim 30, further comprising determining—using the mobile device—an orientation of the mobile device within the physical environment.

32. The method of claim 31, wherein the program plan comprises a pre-defined game requiring a series of physical actions from a player.

33. The method of claim 31, wherein the program plan comprises a pre-defined military training exercise.

34. The method of claim 21, wherein the physical environment comprises a structure dimensioned so that the action of the person may be performed within the structure, and wherein the physical feature is installed as a fixture in the structure.

35. The method of claim 21, wherein the computing device is a mobile device operable to detect the physical feature and provide an augmented reality display showing a representation of the physical feature enhanced with digital imagery.

36. The method of claim 21, wherein the computing device is a mobile device operable to provide haptic feedback as part of the program plan.

37. The method of claim 21, further comprising:
capturing additional data within the space using at least one peripheral device;
transmitting the additional data to a server;
processing—using the server—the additional data to create new information; and
providing the new information to the person through the computing device, wherein the computing device is an orientation-sensing mobile device.

38. The method of claim 37, wherein the program plan defines a gaming or training exercise to be performed by a group of people within the physical environment.

39. The method of claim 38, wherein the physical environment is provided by a building comprising custom fixtures configured to correspond to the program plan, wherein the physical feature is provided by one of the custom fixtures.

40. The method of claim 21, further comprising:
defining an exercise comprising a plurality of checkpoint objectives and a final object within the program plan;
tracking—using the computing device—progress of people through the exercise; and
determining whether a participant has reached the physical feature.
